(19) United States
(12) Patent Application Publication
(10) Pub. No.: US 2019/0235719 A1
(43) Pub. Date: Aug. 1, 2019

(54) ELECTRONIC DEVICE, WEARABLE DEVICE, AND DISPLAY CONTROL METHOD

(71) Applicants: KABUSHIKI KAISHA TOSHIBA, Tokyo (JP); Toshiba Client Solutions Co., LTD., Tokyo (JP)

(72) Inventor: Ryo Hatano, Kodaira Tokyo (JP)

(21) Appl. No.: 16/107,950

(22) Filed: Aug. 21, 2018

(30) Foreign Application Priority Data
Jan. 31, 2018 (JP) 2018-014663

(51) Int. Cl. G06F 3/0485; G06F 3/0488; G06F 1/16; G09G 5/34; G09G 5/38

(52) U.S. Cl. CPC G06F 3/0485; G06F 3/0488; G09G 5/38; G06F 1/163; G09G 5/34; G06F 1/169

(57) ABSTRACT

According to one embodiment, an electronic apparatus includes an object display controller. The object display controller scrolls an object selection screen in a first direction when an operation device is operated to designate a second direction perpendicular to the first direction, by moving, in the second direction, a first object located at a first end of a line of a set of objects which are lined in the first direction on the object selection screen to disappear the first object from the object selection screen, and by displaying a second object different from any one of the set of objects to appear at a second end of the line of the set of objects on the object selection screen from a third direction opposite to the second direction.

### CROSS-REFERENCE TO RELATED APPLICATIONS

This application is based upon and claims the benefit of priority from Japanese Patent Application No. 2018-014663, filed Jan. 31, 2018, the entire contents of which are incorporated herein by reference.

### FIELD

Embodiments described herein relate generally to an electronic device, a wearable device and a display control method.

### BACKGROUND

Recently, an IoT (Internet of Things) age in which many things are connected through the Internet has come. A technique called “edge computing” is required as a tool for network communication and information sharing in offices, factories, and in other various situations. In order to realize the edge computing, development of a practical mobile edge computing device having high degrees of versatility and processing capacity and can be used by a worker (user) on site is needed separately from a data center (or cloud). Thereby, it is expected that promotion of the operational efficiency and productivity improvement at a workplace and the like or load dispersion of data and improvement or the like in a network environment will be achieved.

Meanwhile, conventional mobile devices, such as mobile phones, smartphones, mobile game machines, or the like, may use touch operations on a rectangular touch pad to move objects displayed on a rectangular display. For example, vertical scroll of the list of multiple selection items lined vertically on a display is carried out by a touch operation, which is also called vertical dragging, on the touch pad.

A touch pad, however, has an areal limitation in disposing the touch pad, so that it may sometimes be necessary to shorten the length of a side of the touch pad. In this case, it is difficult to move objects displayed on the display by the touch operation designating the direction along the shortened side. For example, it is difficult to vertically scroll the displayed list, as mentioned in the above example, by the touch operation designating the vertical direction on the touch pad that has a horizontally long and vertically short shape. In addition, if such a touch operation designating the horizontal direction on the touch pad is used to vertically scroll the displayed list, as mentioned above, the operator would have an uncomfortable feeling.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing an example of a remote support system including an electronic device of an embodiment.

FIG. 2 is a block diagram showing an exemplary structure of an operator terminal 12 in FIG. 1.

FIG. 3 is a view showing an example of an external appearance of a wearable device 23 to be connected to a mobile PC 16 in FIG. 1.

FIG. 4 is a view showing an example of an external appearance of a main body 24 of the wearable device 23.

FIG. 5 is a view showing an example of connection between the mobile PC 16 and the wearable device main body 24.

FIG. 6 is a block diagram showing an exemplary structure of the wearable device main body 24.

FIG. 7 is a view showing an example of an external appearance of the mobile PC 16.

FIG. 8 is a block diagram showing an exemplary structure of the mobile PC 16.

FIG. 9 is a view for explaining a first example of moving an object vertically on a display by a touch operation designating a horizontal direction on a touch pad.

FIG. 10 is a view for explaining a second example of moving an object vertically on a display by the touch operation designating a horizontal direction on a touch pad.

FIG. 11 is a view showing an arrangement example of objects on the display.

FIG. 12 is a flowchart showing an example of movement control of objects on the display by the mobile PC 16 in accordance with the touch operation on the touch pad.

### DETAILED DESCRIPTION

Various embodiments will be described hereinafter with reference to the accompanying drawings.

In general, according to one embodiment, an electronic device is connectable to a wearable device including a display and an operation device. The electronic apparatus includes an object display controller. The object display controller controls display of an object on the display in response to an operation of the operation device. The object display controller displays an object selection screen on the display. The object selection screen comprises a set of objects organized in a line in a first direction. The set of objects comprises selection items. When the operation device is operated to designate a second direction perpendicular to the first direction, the object display controller moves a first object located at a first end of the line of the set of objects in the second direction to disappear the first object from the object selection screen. The object display controller displays a second object different from any one of the set of objects at a second end of the line of the set of objects on the object selection screen to appear the second object from a third direction opposite to the second direction. Thereby, the object selection screen is scrolled in the first direction.

Embodiments of the present invention will be described below by referring to the accompanying drawings. The following disclosure is presented by way of example only, and is not intended to limit the scope of the invention by the description of the disclosure. Various modifications that will readily occur to those skilled in the art are indeed made without departing from the spirit or scope of the disclosure. For clearer explanation, the accompanying drawings may be illustrated schematically by changing size, shape, and the like of constituent components relative to the actual dimensions of the embodiments. The same reference numbers are given in some cases to the corresponding elements in the drawings, and the detailed description of such elements will not be repeated.

[Remote Support System]

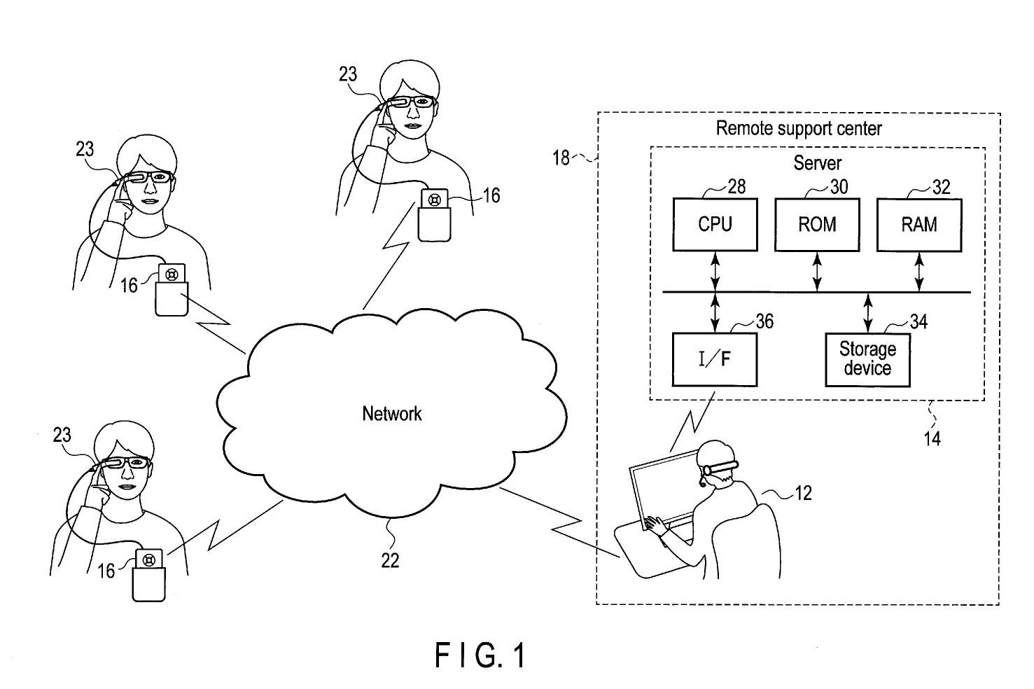

FIG. 1 is a block diagram showing an example of a remote support system configured to realize edge computing. The remote support system is configured to be used by an operator at the rear to support a user, for example, a worker at a workplace from a remote place. Examples of work at the workplace include a complicated maintenance service, picking operation in a distribution warehouse, monitoring of a workplace, disaster relief/medical support, and the like. The worker side of the workplace is also called a front end, and the operator side at the rear is also called a back end. In the remote support system, a mobile personal computer (PC) (also called a mobile edge computing device in some cases) 16 carried by the worker and remote support center (data center) 18 located at a position distant from the worker are connected to each other through a network 22, such as the Internet, so that communication can be carried out between them. The mobile PC 16 and remote support center 18 may be connected to the network 22 through wired LAN cables or may be connected to the network 22 through a wireless LAN, Bluetooth (registered trade mark), and the like.

A wearable device 23 is connected to the mobile PC 16. Although FIG. 1 shows an example in which the wearable device 23 is connected to the mobile PC through a cable, the wearable device 23 may also be connected to the mobile PC 16 through a wireless LAN, Bluetooth or the like. The wearable device 23 is provided with a camera and display device. An image shot by the camera may be displayed on the display device. An image shot by the camera may be transmitted to the mobile PC 16, and the image transmitted from the mobile PC 16 may be displayed on the display device.

As shown in FIG. 1, it is also possible for a plurality of workers to communicate with each other through the network. In this case, communication may also be carried out through the remote support center 18, and communication can also be carried out only between the workers without being carried out through the operator of the remote support center 18.

The remote support center 18 is provided with an operator terminal 12 and server 14. The remote support center 18 makes a voice call or information exchange between the mobile PC 16 (and wearable device 23) and operator terminal 12. It is possible to carry out video distribution of a real-time image shot by the wearable device 23 connected to the mobile PC 16 to the operator terminal 12, and it is also possible to carry out mutual transmission/reception of an image between the mobile PC 16 and operator terminal 12. Further, it is also possible to transmit a text message from the operator terminal 12 to the mobile PC 16. For example, in the picking operation in the distribution warehouse, a place of a picking item is displayed on the wearable device 23, whereby hands-free picking can be realized.

The remote support typically include, for example, the following functions:

A voice call function of carrying out an interactive voice call between the mobile PC 16 and operator terminal 12;

A live image distribution function of carrying out video distribution of a real-time image shot by the wearable device 23 to the operator terminal 12 during a voice call;

A function of carrying out transmission/reception of a still image between the mobile PC 16 and operator terminal 12 during a voice call (The mobile PC 16 transmits a shot still image or capture image being video-distributed to the operator terminal 12. The operator terminal 12 edits the received picture by writing characters or pictures, and transmits the edited image to the mobile PC 16. The still image received by the mobile PC 16 is stored in a folder in the mobile PC 16, and can be browsed.

A screen sharing function of displaying the entire desk-top screen of the operator terminal 12 or a window of an arbitrary application program on the wearable device 23 during a voice call; and

A text message transmitting function of transmitting a text message from the operator terminal 12 to the mobile PC 16.

The server 14 is configured to carry out processing for remote support in place of or in cooperation with the operator terminal 12, and is provided with a processor (CPU) 28, ROM 30, RAM 32, and a storage device 34 constituted of a hard disk drive (HDD) or solid-state drive (SSD), and interface 36. The operator terminal 12 may be made to have all the functions of the server 14, and the server 14 may be omitted.

[Operator Terminal 12]

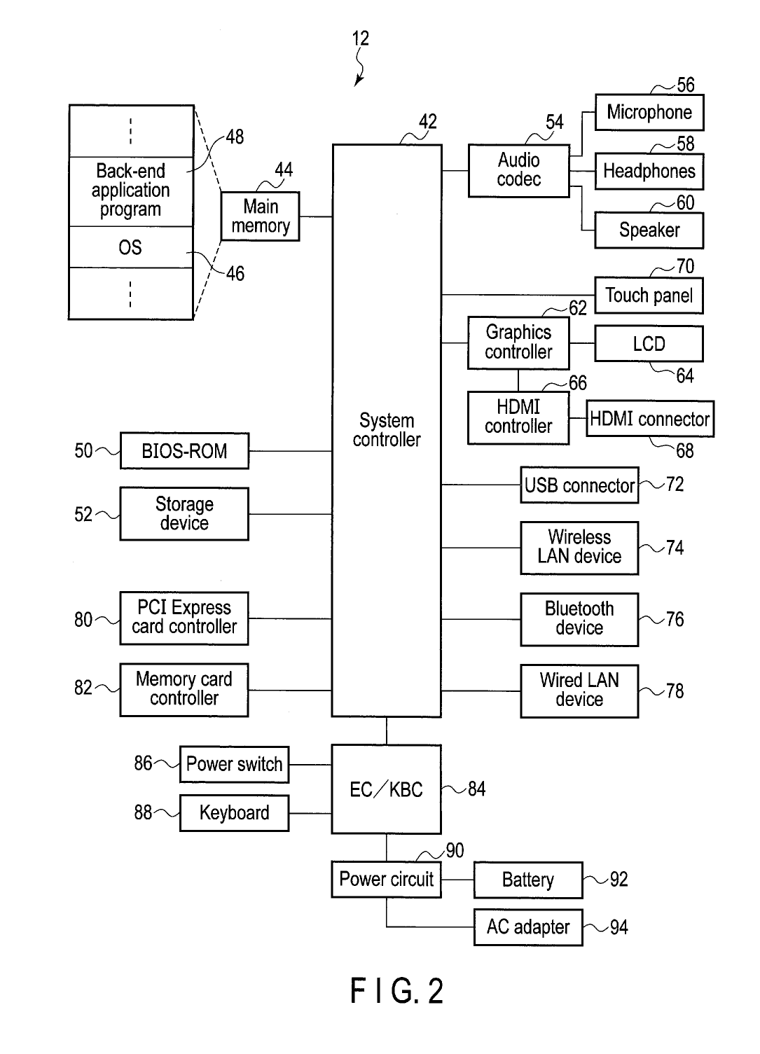

FIG. 2 is a block diagram showing an exemplary structure of the operator terminal 12. The operator terminal 12 is constituted of a desktop PC, notebook PC or the like.

The operator issues an instruction to the worker having the mobile PC 16 by a conversation or image while confirming the situation of the workplace on the basis of a real-time image by using the operator terminal 12. The operator can write pictures or characters to the image file received from the mobile PC 16 by using the operator terminal 12 to edit the image file, transmit the edited image file to the mobile PC 16, and store the edited image file in the operator terminal 12.

The operator terminal 12 is provided with a system controller 42 including a processor. A main memory 44, BIOS-ROM 50, a storage device 52 constituted of HDD or SSD, audio codec 54, graphics controller 62, touch panel 70, USB (registered trade mark) connector 72, wireless LAN device 74, Bluetooth device 76, wired LAN device 78, PCI Express (registered trade mark) card controller 80, memory card controller 82, embedded controller/keyboard controller (EC/KBC) 84, and the like are connected to the system controller 42.

The system controller 42 executes various programs to be loaded from the storage device 52 into the main memory 44. These programs include an operating system (OS) 46, and back-end application program 48 for remote support. The system controller 42 also executes the Basic Input/Output System (BIOS) stored in the BIOS-ROM 50 which is a nonvolatile memory. The BIOS is a system program for hardware control.

The audio codec 54 converts a digital audio signal which is an object to be reproduced into an analog audio signal, and supplies the converted analog audio signal to headphones 58 or a speaker 60. Further, the audio codec 54 converts an analog audio signal input thereto from a microphone 56 into a digital signal. The microphone 56 and headphones 58 may be provided singly, and may also be provided in an integrated manner as an intercom.

The graphics controller 62 controls a liquid crystal display (LCD) 64 to be used as a display monitor of the operator terminal 12. The touch panel 70 is overlaid on the screen of the LCD 64, and is configured in such a manner as to allow a handwriting input operation to be carried out on the screen of the LCD 64 by means of a touch-pen or the like. An HDMI (registered trade mark) controller 66 is also connected to the graphics controller 62. The HDMI controller 66 is connected to an HDMI connector 68 for connection to en external display device.

The wireless LAN device 74 executes wireless LAN communication of the IEEE802.11 standard for the purpose of connection to the network 22. The Bluetooth device 76 executes wireless communication of the Bluetooth standard for the purpose of connection to an external device. The wired-LAN device 78 executes wired LAN communication of the IEEE802.3 standards for the purpose of connection to the network 22. As described above, the connection between the operator terminal 12 and network 22 may be made by wireless communication or may be made by wire communication.

The PCI Express card controller 80 carries out communication of the PCI Express standard between the operator terminal 12 and external device. The memory card controller 82 writes data to a storage medium, for example, a memory card such as an SD (Secure Digital) card (registered trade mark), and reads data from the memory card.

The EC/KBC 84 is a power management controller, and is realized as a one-chip microcomputer incorporating therein also a keyboard controller configured to control a keyboard 88. The EC/KBC 84 has a function of powering on or powering off the operator terminal 12 according to an operation of a power switch 86. Control of the power-on and power-off is executed by the cooperation between the EC/KBC 84 and a power circuit 90. Even while the operator terminal 12 is in the power-off state, the EC/KBC 84 operates by power from a battery 92 or AC adaptor 94. The power circuit 90 uses the power from the battery 92 or power from the AC adaptor 94 to be connected as an external electric power supply to generate the power to be supplied to each component.

[Wearable Device 23]

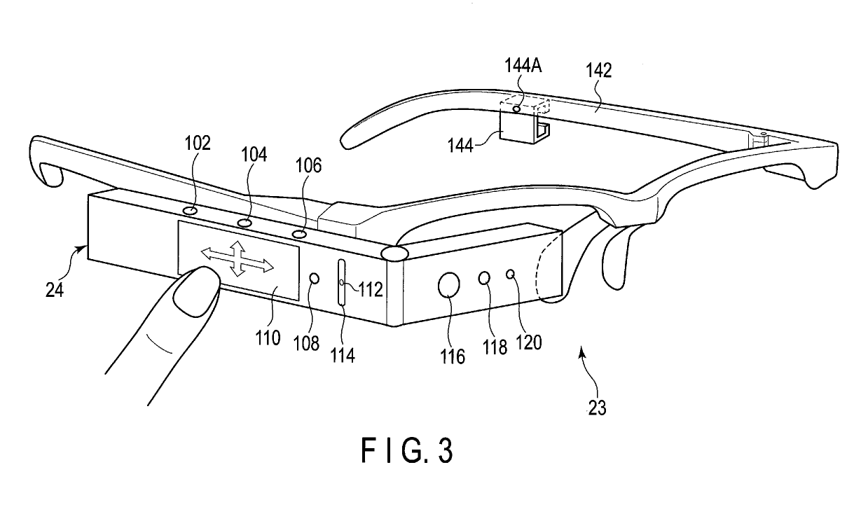

FIG. 3 shows an example of an external appearance of the wearable device 23 to be connected to the mobile PC 16. The wearable device 23 is provided with an eyeglass frame 142 and wearable device main body 24. The eyeglass frame 142 may have a shape obtained by removing lenses from general eyeglasses and is worn on the face of the worker. The eyeglass frame 142 may have a structure to which eyeglasses can be attached. When the worker habitually uses eyeglasses at all times, lenses of degrees identical to the habitually used eyeglasses may be attached to the eyeglass frame 142.

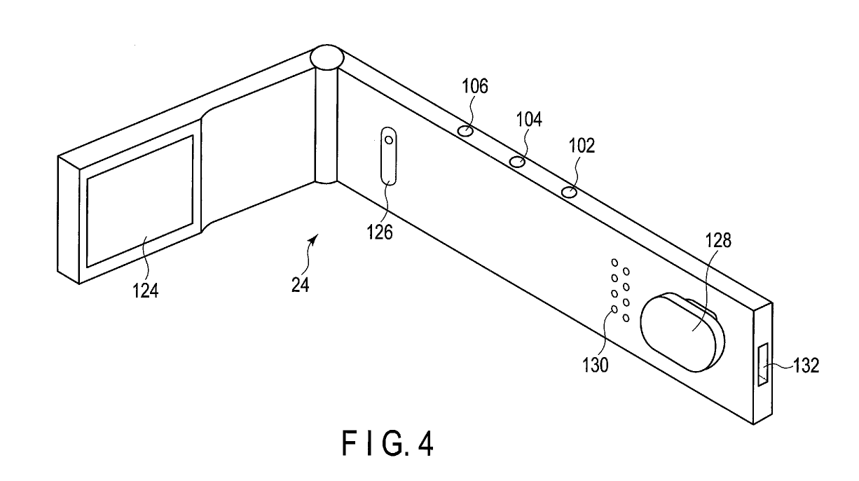

The eyeglass frame 142 is provided with mounting brackets 144 on both the right and left temples thereof. The wearable device main body 24 is attached to and detached from one of the mounting brackets 144 on the right or left temple. In FIG. 3, the mounting bracket 144 on the temple on the right side of the worker is hidden behind the wearable device main body 24, and hence is not shown. As described above, the wearable device main body 24 is provided with a display device 124 (shown in FIG. 4). The display device 124 is configured in such a way as to be viewed by one eye. Therefore, the mounting brackets 144 are provided on both the right and left temples so that the wearable device main body 24 can be attached to the mounting bracket on the dominant eye side. The wearable device main body 24 need not be detachably attached to the eyeglass frame 142 by means of the mounting bracket 144. The wearable devices 23 for the right eye and left eye in which the wearable device main bodies 24 are respectively fixed to the eyeglass frames 142 on the right and left frames may be prepared. Furthermore, the wearable device main body 24 may not be attached to the eyeglass frame 142, but may be attached to the head of the worker by using a helmet or goggle.

An engaging piece 128 (shown in FIG. 4) of the wearable device main body 24 is forced between upper and lower frames of the mounting bracket 144, whereby the wearable device main body 24 is attached to the eyeglass frame 142. When the wearable device main body 24 is to be detached from the eyeglass frame 142, the wearable device main body 24 is plucked out of the mounting bracket 144.

In a state where the wearable device main body 24 is attached to the mounting bracket 144, the engaging piece 128 is somewhat movable backward and forward in the mounting bracket 144. Accordingly, the wearable device main body 24 is adjustable in the front-back direction so that the worker's eye can be brought to a focus on the display device 124. Furthermore, the mounting bracket 144 is rotatable around an axis 144A perpendicular to the temple. After the wearable device main body 24 is attached to the eyeglass frame 142, the wearable device main body 24 is adjustable in the vertical direction so that the display device 124 can be positioned on the worker's line of sight. Moreover, the rotational angle of the mounting bracket 144 is about 90 degrees and, by largely rotating the mounting bracket 144 in the upward direction, the wearable device main body 24 can be flipped up from the eyeglass frame 142. Thereby, even when it is difficult to watch the real thing because the field of view is obstructed by the wearable device main body 24 or even when the wearable device main body 24 interferes with surrounding objects in a small space, it is possible to temporarily divert/restore the wearable device main body 24 from/to the field of view of the worker without detaching/reattaching the entire wearable device 23 from/to the face of the worker.

[Wearable Device Main Body 24]

The wearable device main body 24 is constituted of a side part to be along the temple of the eyeglass frame 142, and front part to be positioned on the line of sight of one eyeball of the worker. The angle which the front part forms with the side part is adjustable.

As shown in FIG. 3, on the outside surface of the front part, a camera 116, light 118, and camera LED 120 are provided. The light 118 is an auxiliary lighting fixture emitting light at the time of shooting a dark object. The camera LED 120 is configured to be turned on at the time of shooting a photograph or video to thereby cause the objective person to be photographed to recognize that he or she is to be photographed.

On the top surface of the side part of the wearable device main body 24 attached to the right side temple, first, second, and third buttons 102, 104, and 106 are provided. When the dominant eye of the worker is the left eye, the wearable device main body 24 is attached to the left side temple. The top and the bottom of the wearable device main body 24 are reversed according to whether the wearable main body 24 is attached to the right side temple or to the left side temple. Therefore, the first, second, and third buttons 102, 104, and 106 may be provided on both the top surface and undersurface of the side part.

On the outside surface of the side part, a touch pad 110, fourth button 108, microphone 112, and illuminance sensor 114 are provided. The touch pad 110 and fourth button 108 can be operated by a forefinger. When the wearable device main body 24 is attached to the right side temple, the buttons 102, 104, and 106 are arranged at positions at which the buttons 102, 104, and 106 can be operated by a forefinger, middle finger, and third finger, respectively. The touch pad 110 is configured such that the movement of finger in up and down directions or back and forth directions on the surface on the touch pad 110 as indicated by arrows can be detected. The movement to be detected includes flicking of a finger for grazing the surface quickly in addition to dragging of a finger for moving the finger with the finger kept in contact with the surface. Upon detection of up-and-down or back-and-force movement of the worker's finger, the touch pad 110 inputs a command. In this description, a command implies an executive instruction to execute specific processing to be issued to the wearable device main body 24. Operation procedures for the first to fourth buttons 102, 104, 106, and 108, and touch pad 110 are determined in advance by the application program.

For example,

when the third button 106 is pressed once, item selection/item execution is carried out,

when the third button 106 is pressed for a long time, a list of activated application programs is displayed,

when the second button 104 is pressed once, the screen returns to the home screen,

when the second button 104 is pressed for a long time, a menu of quick settings is displayed, and

when the first button 102 is pressed once, cancellation (operation identical to the operation of the Esc key of the keyboard) of an operation is executed.

Regarding the operation of the touch pad 110, for example,

when the touch pad 110 is dragged up and down, the cursor is moved up and down,

when the touch pad 110 is flicked forward (to the front of the head), the left icon is selected (continuously scrolled),

when the touch pad 110 is flicked backward (to the back of the head), the right icon is selected (continuously scrolled),

when the touch pad 110 is dragged forward, the left icon is selected (items are scrolled one by one), and

when the touch pad 110 is dragged backward, the right icon is selected (items are scrolled one by one).

The first button 102 is arranged at such a position as to be operated by a forefinger, second button 104 at a position by a middle finger, third button 106 at a position by a third finger, and fourth button 108 at a position by a little finger. The reason why the fourth button 108 is provided not on the top surface of the side part, but on the outside surface of the side part in FIG. 3 is that there is space restriction. The fourth button 108 may also be provided on the top surface of the side part in the same manner as the first to third buttons 102, 104, and 106. The illuminance sensor 114 detects the illuminance of the surrounding area in order to automatically adjust the brightness of the display device.

FIG. 4 shows an example of an external appearance of the back side of the wearable device main body 24. On the inner side of the front part, a display device 124 constituted of an LCD is provided. On the inner side of the side part, a microphone 126, speaker 130, and engaging piece 128 are provided. The microphone 126 is provided at a front position of the side part, and speaker 130 and engaging piece 128 at a rear position of the side part. Headphones may be used in place of the speaker 130. In this case, the microphone and headphones may also be provided in an integrated manner as an intercom in the same manner as the operator terminal 12.

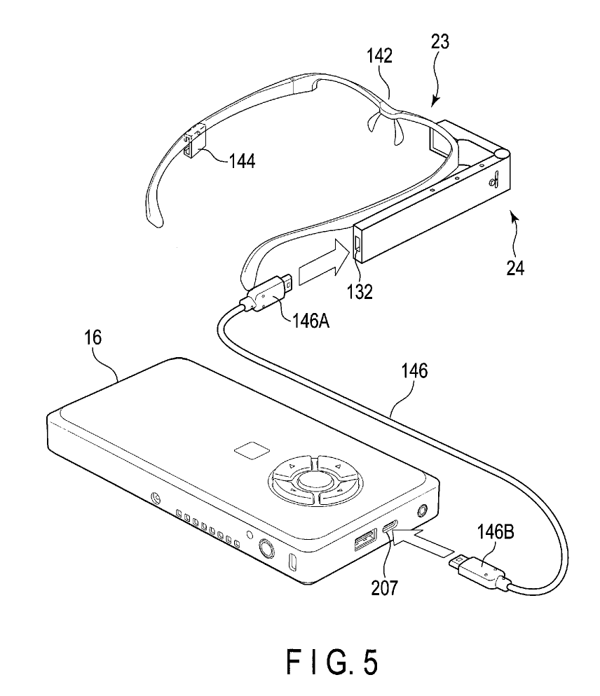

FIG. 5 shows an example of connection between the mobile PC 16 and wearable device main body 24. At a rear position of the side part, a receptacle 132 into which a plug 146A at one end of a cable 146 conforming to the USB type-C (registered trade mark) standard is to be inserted is provided. A plug 146B at the other end of the USB type-C cable 146 is inserted into a connector 207 conforming to the USB type-C standard provided on an upper end face of the mobile PC 16. As described above, the wearable device main body 24 is connected to the mobile PC 16 through the USB type-C cable 146, and image signals and the like are transmitted from/to the wearable device main body 24 to/from the mobile PC 16 through the USB type-C cable 146. The wearable device main body 24 may also be connected to the mobile PC 16 by means of wireless communication such as a wireless LAN, Bluetooth, and the like.

In the embodiment, the wearable device main body 24 is not provided with a battery or DC terminal serving as a drive power supply, and the drive power is supplied from the mobile PC 16 to the wearable device main body 24 through the USB type-C cable 146. However, the wearable device main body 24 may also be provided with a drive power supply.

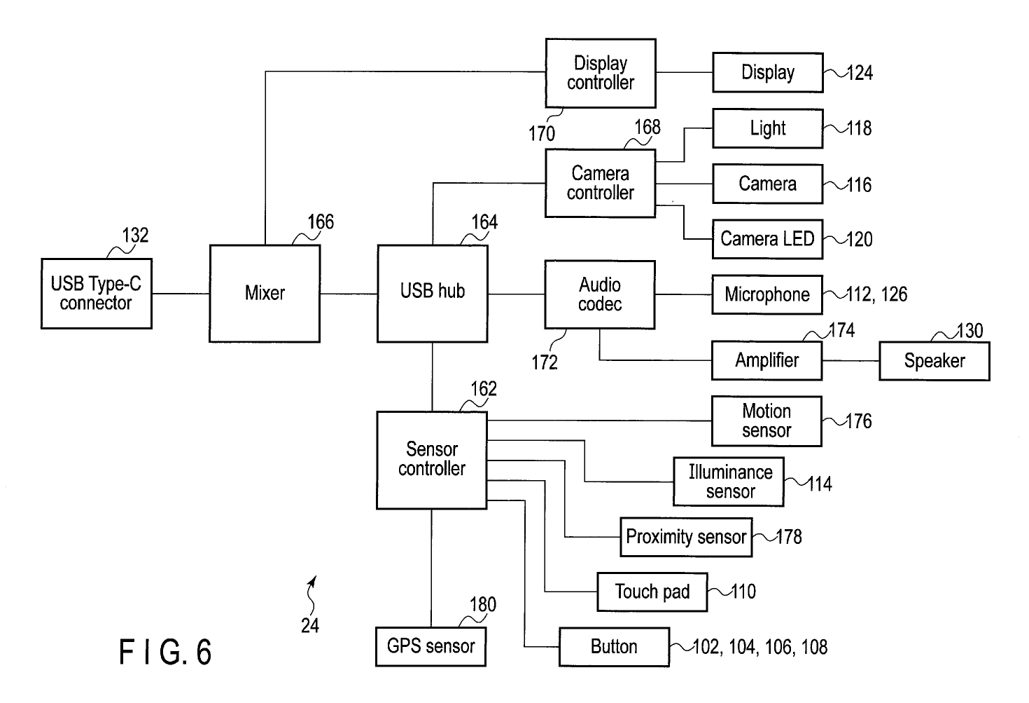

FIG. 6 is a block diagram showing an exemplary structure of the wearable device main body 24. The USB type-C connector 132 is connected to a mixer 166. A display controller 170 and USB hub 164 are respectively connected to a first terminal, and second terminal of the mixer 166. The display device 124 is connected to the display controller 170. A camera controller 168, audio codec 172, and sensor controller 162 are connected to the USB hub 164. The camera 116, light 118, and camera LED 120 are connected to the camera controller 168. Audio signals from the microphones 112 and 126 are input to the audio codec 172, and audio signal from the audio codec 172 is input to the speaker 130 through an amplifier 174.

A motion sensor (for example, acceleration, geomagnetism, gravitation, gyroscopic sensor, etc.) 176, the illuminance sensor 114, a proximity sensor 178, the touch pad 110, the first to fourth buttons 102, 104, 106, and 108, and a GPS sensor 180 are connected to the sensor controller 162. The sensor controller 162 processes detection signals from the motion sensor 176, illuminance sensor 114, proximity sensor 178, touch pad 110, first to fourth buttons 102, 104, 106, and 108, and GPS sensor 180, and supplies a command to the mobile PC 16. Although not shown in FIG. 4, the motion sensor 176, and proximity sensor 178 are arranged inside the wearable device main body 24. The motion sensor 176 detects a motion, direction, attitude, and the like of the wearable device main body 24. The proximity sensor 178 detects attachment of the wearable device 23 on the basis of approach of a face, finger and the like of the worker thereto.

[Mobile PC 16]

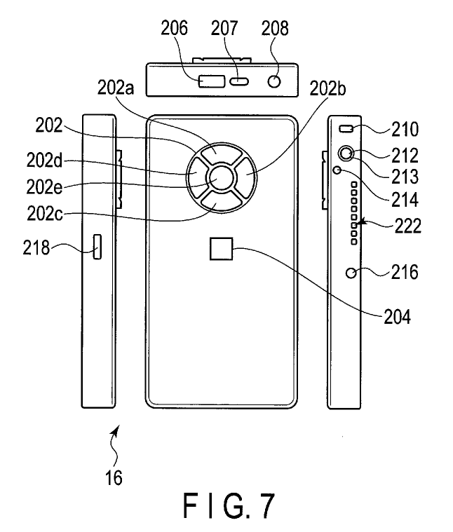

FIG. 7 shows an example of an external appearance of the mobile PC (mobile edge computing device) 16. The mobile PC 16 is a small-sized PC that can be held by one hand, and has a small size and light weight, i.e., a width thereof is about 10 cm or less, height thereof is about 18 cm or less, thickness thereof is about 2 cm, and weight thereof is about 300 g. Accordingly, the mobile PC 16 can be held in a pocket of the work clothing of the worker, holster to be attached to a belt, or a shoulder case, and is wearable. Although the mobile PC 16 incorporates therein semiconductor chips such as the CPU, semiconductor memory, and the like, and storage devices such as a Solid State Disk (SSD), and the like, the mobile PC 16 is not provided with a display device and hardware keyboard for input of characters.

On the front surface of the mobile PC 16, five buttons 202 constituted of an up button 202a, right button 202b, down button 202c, left button 202d, and decision button 202e (also called a center button or enter button) are arranged, and fingerprint sensor 204 is arranged below the five buttons 202. The mobile PC 16 is not provided with a hardware keyboard for input of characters, and a password number (also called a PIN) cannot be input. Therefore, the fingerprint sensor 204 is used for user authentication at the time of login of the mobile PC 16. The five buttons 202 can input a command.

User authentication at the time of login may be carried out by allocating numeric characters to the buttons 202a to 202d of the five buttons 202, and inputting a password number by using the five buttons 202. In this case, the fingerprint sensor 204 can be omitted. Numeric characters are allocated to the four buttons other than the decision button 202e, and the number of the numeric characters is only four. Thus, there is a possibility of numeric characters input in a random manner being coincident with the password number. However, by making the digit number of the password number large, it is possible to make the probability that the numeric characters input in a random manner will be coincident with the password number low. Authentication by the five buttons 202 may be enabled in also a mobile PC 16 provided with a fingerprint sensor 204. Although one mobile PC 16 may be shared among a plurality of workers, it is not possible to cope with such a case by only the fingerprint authentication.

The operations identical to those of the buttons 102, 104, 106, and 108, and touch pad 110 of the wearable device main body 24 can also be applied to the five buttons 202. The worker cannot watch the state where the buttons 102, 104, 106, and 108, and touch pad 110 of the wearable device main body 24 are being operated. Therefore, it may be necessary for a worker to become accustomed to carrying out an intended operation depending on the worker. Further, the buttons 102, 104, 106, and 108, and touch pad 110 are small in size, and thus they may be difficult to operate. In the embodiment, the five buttons 202 of the mobile PC 16 can also be operated in the same manner as above, and hence the above-mentioned fear can be dispelled. The operation procedures of the five buttons 202 are determined by the application program.

For example,

when the decision button 202e is pressed once, item selection/item execution is carried out (corresponding to pressing once of the third button 106 in the wearable device main body 24),

when the decision button 202e is pressed for a long time, ending or cancellation of an operation is carried out (corresponding to pressing once of the first button 102 in the wearable device main body 24),

when the up button 202a is pressed once, the cursor is moved upward (corresponding to upward drag on the touch pad 110 in the wearable device main body 24),

when the up button 202a is pressed for a long time, a list of activated application programs is displayed (corresponding to pressing the third button 106 for a long time in the wearable device main body 24),

when the down button 202c is pressed once, the cursor is moved downward (corresponding to downward drag on the touch pad 110 in the wearable device main body 24),

when the down button 202c is pressed for a long time, a menu of quick settings is displayed (corresponding to pressing of the second button 104 for a long time in the wearable device main body 24),

when the left button 202d is pressed once, the right icon is selected (corresponding to backward drag/flick on the touch pad 110 in the wearable device main body 24), and

when the right button 202b is pressed once, the left icon is selected (corresponding to forward drag/flick on the touch pad 110 in the wearable device main body 24).

On the upper side face of the mobile PC 16, a USB 3.0 connector 206, USB type-C connector 207, and audio jack 208 are provided.

On one side face (side face on the left side when viewed from the front) of the mobile PC 16, a memory card slot 218 for a memory card is provided. The memory card includes, for example, an SD card, micro SD card (registered trade mark), and the like.

On the other side face (side face on the right side when viewed from the front) of the mobile PC 16, a slot 210 for Kensington Lock (registered trade mark), power switch 212, power LED 213, DC IN/battery LED 214, DC terminal 216, and ventilation holes 222 for cooling are provided. The power LED 213 is arranged around the power switch 212, and turned on during the period of power-on. The DC IN/battery LED 214 indicates the state of the mobile PC 16 such as whether or not the battery is being charged, and remaining battery level. Although the mobile PC 16 can be driven by the battery, the mobile PC 16 can also be driven in the state where the AC adaptor is connected to the DC terminal 216. Although not shown, the back side of the mobile PC 16 is configured such that the battery can be replaced with a new one by a one-touch operation.

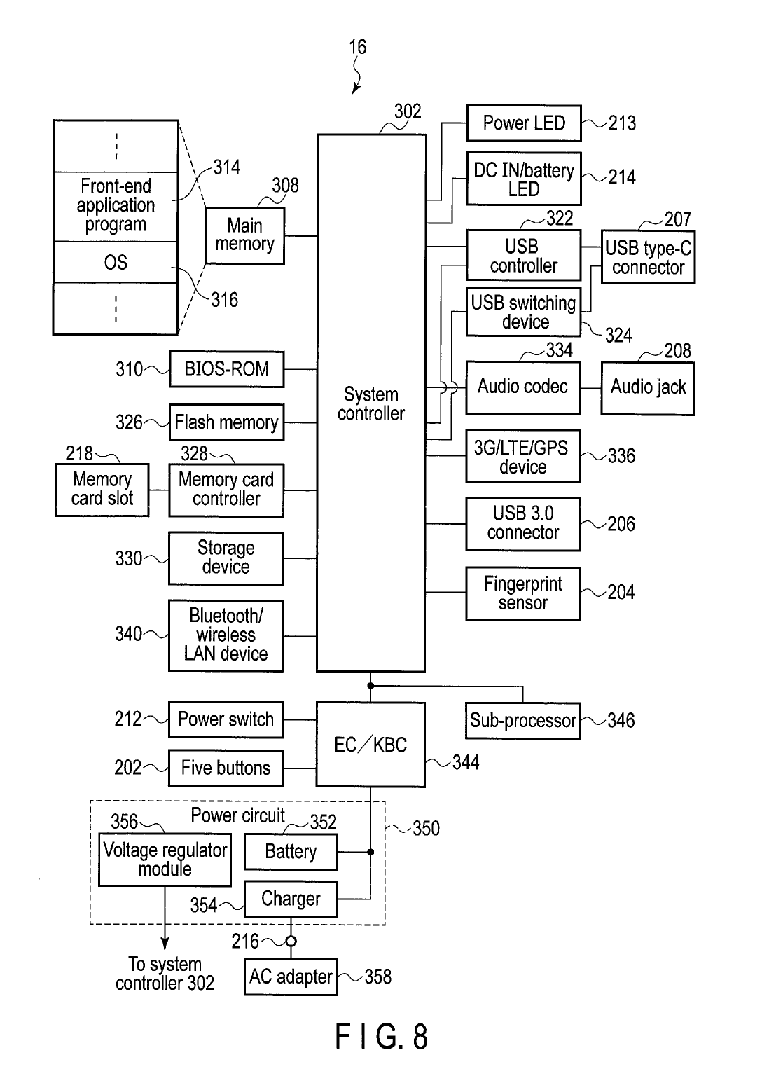

FIG. 8 is a block diagram showing an exemplary structure of the mobile PC 16. The mobile PC 16 can carry out video distribution of an image shot by the wearable device main body 24 to the operator terminal 12, and enables browse of the image received from the operator terminal 12. For this reason, the mobile PC 16 is provided with a camera function and viewer function. The camera function is a function of shooting a photograph or video by means of the camera 116 of the wearable device main body 24. The shot photograph and video are stored in a camera folder (not shown) in the mobile PC 16, and can be browsed by the viewer function. The viewer function is a function of enabling browse of a file stored in the camera folder. The types of the files include image, moving image, PDF file, photograph and video shot by the camera function, image received from the operator terminal 12, image transmitted to the operator terminal 12, and file stored in a user folder (not shown) in the mobile PC 16.

The mobile PC 16 is provided with a system controller 302. The system controller 302 is constituted of a processor (CPU) and controller/hub. A main memory 308, the power LED 213, the DC IN/battery LED 214, and a USB controller 322 are connected to the processor of the system controller 302. A flash memory 326, a memory card controller 328, a storage device 330 constituted of an HDD or SSD, a USB switching device 324, an audio codec 334, a 3G/LTE/GPS device 336, the fingerprint sensor 204, the USB 3.0 connector 206, a Bluetooth/wireless LAN device 340, and an EC/KBC 344 are connected to the controller/hub of the system controller 302.

The system controller 302 executes various programs to be loaded from the storage device 330 into the main memory 308. These programs include an OS 316, and front-end application program 314 for remote support. The front-end application program 314 includes a screen direction control program.

The audio codec 334 converts a digital audio signal which is an object to be reproduced into an analog audio signal, and supplies the converted analog signal to the audio jack 208. Further, the audio codec 334 converts an analog audio signal input from the audio jack 208 into a digital signal.

The memory card controller 328 gains access to a memory card such as an SD card to be inserted into the memory card slot 218, and controls read/write of data from/to the SD card.

The USB controller 322 carries out control of transmission/reception of data to/from the USB type-C cable 146 (shown in FIG. 5) connected to the USB type-C connector 207 or the USB 3.0 cable (not shown) connected to the USB 3.0 connector 206.

Although not shown, a port extension adaptor including ports or connectors according to several interfaces can be connected also to the USB type-C connector 207, and an interface which is not provided in the mobile PC 16, such as the HDMI or the like, can be used.

The Bluetooth/wireless LAN device 340 executes wireless communication conforming to the Bluetooth/IEEE802.11 standard for the purpose of connection to the network 22. The connection to the network 22 may not depend on wireless communication, and may depend on wired LAN communication conforming to the IEEE802.3 standard.

The fingerprint sensor 204 is used for fingerprint authentication at the time of startup of the mobile PC 16.

A sub-processor 346, the power switch 212, and the five buttons 202 are connected to the EC/KBC 344. The EC/KBC 344 has a function of turning on or turning off the power to the mobile PC 16 according to the operation of the power switch 212. The control of power-on and power-off is executed by the cooperative operation of the EC/KBC 344 and power circuit 350. Even during a power-off period of the mobile PC 16, the EC/KBC 344 operates by the power from a battery 352 or AC adaptor 358 connected as an external power supply. The power circuit 350 uses the power from the battery 352 or AC adaptor 358 to thereby generate power to be supplied to each component. The power circuit 350 includes a voltage regulator module 356. The voltage regulator module 356 is connected to the processor in the system controller 302.

Although the mobile PC 16 is constituted as a body separate from the wearable device main body 24, the mobile PC 16 may be incorporated into the wearable device main body 24, and both of them may also be integrated into one body.

[Object Display Control]

As described above by referring to FIG. 3, the wearable device main body 24 is attached to the temple of the dominant eye side of the spectacle frame 142. Therefore, the touch pad 110 attached to the side portion of the wearable device main body 24 should naturally be formed to a horizontally long and vertically short shape to suit the temple of the spectacle frame 142. In addition, the display 124 provided on the front portion of the wearable device main body 24 needs to be formed to a horizontally long shape which is substantially similar to the LCD 64 used as a display monitor of the operator terminal 12, because the display 124 may display the entire desktop screen of the operator terminal 12.

In the case of the horizontally long display, it is assumed that the text information is also displayed horizontally. If, for example, the list of selection items is displayed, each item is displayed in a horizontally long object and such choices are arranged vertically to create a list. When all objects are not displayed at once on the display, an operation which is called scroll is carried out. Specifically, an operation to move the display target of the list in a vertical direction is carried out. With the touch pad 110 shaped as mentioned above, the touch operation designating the horizontal direction along the temple is easy, but the touch operation designating the vertical direction is difficult.

This problem is solved by the present embodiment by carrying out the vertical movement of the object displayed on the display 124 without generating the uncomfortable feeling by the touch operation designating the horizontal direction on the touch pad 110. The relationship between the horizontal direction and the vertical direction is described herein as merely an example. Alternatively, the object displayed on a vertically long display can be controlled without any uncomfortable feeling by the touch operation designating the vertical direction on the touch pad 110.

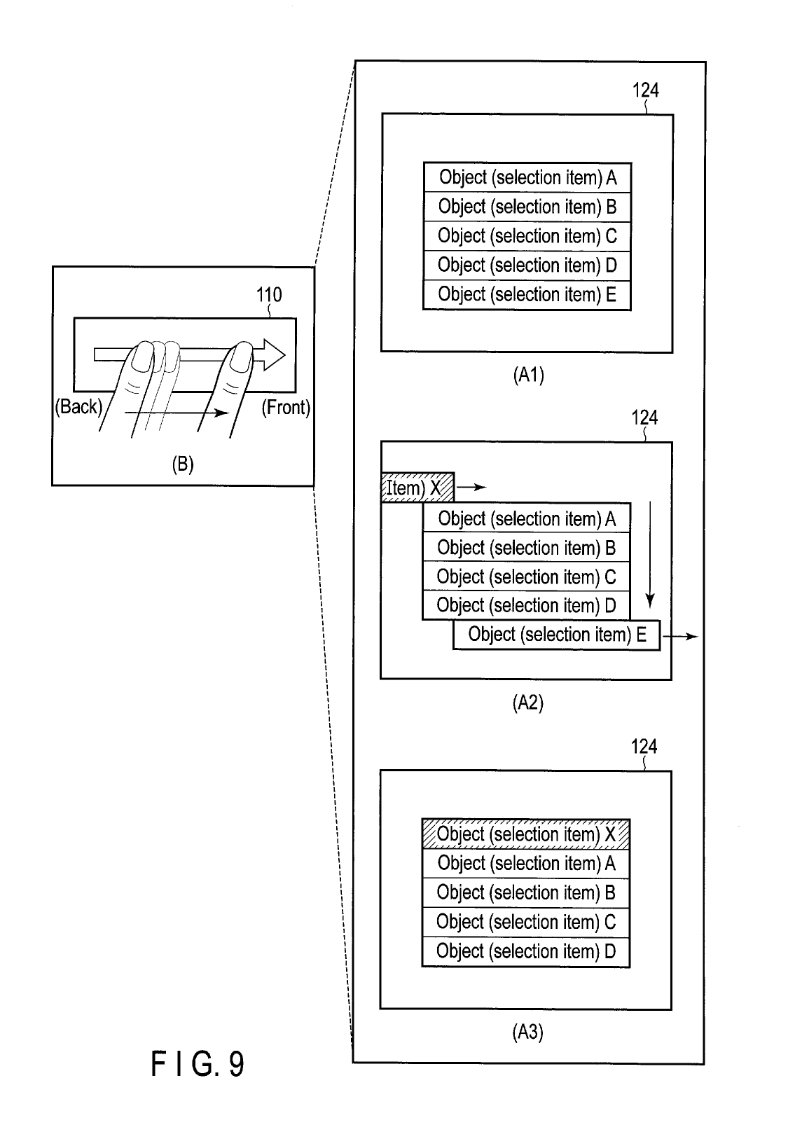

Referring to FIG. 9, a first example of moving the object displayed on the display 124 to move the object vertically by the horizontal touch operation designating the horizontal direction on the touch pad 110 is described. Specifically, the touch operation on the touch pad 110 in the case of moving the object displayed on the display 124 downward is described.

Assume herein that an object selection screen displays multiple objects lined vertically as selection items on the display 124. In addition, assume that the object selection screen can simultaneously present a maximum of five objects. The mobile PC 16 that executes the front end application program 314 controls displaying the object selection screen on the display 124 and entering contents of the operation to the object selection screen by the worker. In other words, the mobile PC 16 controls displaying the object on the display 124 of the wearable device 23 and moving the object in accordance with the touch operation on the touch pad 110 of the wearable device 23.

In FIG. 9, (A1) illustrates the display state of the object selection screen on the display 124 before the touch operation is carried out on the touch pad 110. For example, five objects including objects A, B, C, D, and E are presented in the object selection screen. Meanwhile, (B) illustrates the touch operation on the touch pad 110 to scroll down the object selection screen.

As illustrated at (B) of FIG. 9, in order to scroll down the object selection screen or move the objects downward, the worker carries out the touch operation in, for example, the forward direction on the touch pad 110 along the temple of the spectacle frame 142. As used herein, the forward direction indicates a direction of the line of sight of the worker. When the wearable device main body 24 is attached to the right temple of the spectacle frame 142, the forward direction corresponds to a right-hand direction on the touch pad 110. When the wearable device main body 24 is attached to the left temple of the spectacle frame 142, the forward direction corresponds to a left-hand direction on the touch pad 110. The mobile PC 16 detects whether the wearable device main body 24 is attached to the left or right temple of the spectacle frame 142, based on the detection result transmitted from the wearable device main body 24 and detected by the motion sensor 176, such as an acceleration sensor, a geomagnetic sensor, a gravity sensor, or a gyro sensor, or a proximity sensor 178.

Specifically, the touch operation designating the vertical direction on the touch pad 110 should be carried out to move the object vertically on the display 124. The present embodiment, however, can move the object vertically on the display 124 by the touch operation designating the horizontal direction without giving uncomfortable feeling to the worker. Thus, the difficulty in carrying out the touch operation designating the vertical direction due to the short length in the vertical direction of the touch pad 110 is eliminated.

(A2) illustrates a display state of the object selection screen on the display 124 when the touch operation to designate the forward direction on the touch pad 110 is carried out halfway.

The mobile PC 16 gradually moves the objects on the display 124 downward in accordance with the touch operation designating the forward direction on the touch pad 110. At the same time, the mobile PC 16 gradually moves the object E, which is a target for scroll-out and located at the bottom of the objects A, B, C, D, and E, in the direction designated by the touch operation on the touch pad 110 to eventually delete the object E from the display 124. Also, the mobile PC 16 causes an object X which is a target for scroll-in to appear on the display 124 from the side (left side) opposite to the direction designated by the touch operation on the touch pad 110 to gradually move the object X in a direction (to the right) designated by the touch operation on the touch pad 110. The object X appears and is put over the object A which is located at the top of the objects A, B, C, D, and E and moves.

(A3) illustrates a display state of the object selection screen on the display 124 when the touch operation designating the forward direction on the touch pad 110 is finished.

The object E that has been located at the bottom of the objects A, B, C, D, and E before the touch operation has started on the touch pad 110 is deleted, and the other objects A, B, C, and D are each moved to one step lower of the list, with the new object X being disposed at the top where the object A is used to be located. Thus, the downward scrolling of the object selection screen has been completed.

As illustrated in (A2) of FIG. 9, the present embodiment carries out the actions matching the directions designated by the touch operation on the touch pad 110 as indicating the movement of the object E which is the target for scroll-out and the movement of the object X which is the target for scroll-in. Thus, the object displayed on the display 124 can be moved vertically without generating the uncomfortable feeling with the touch operation designating the horizontal direction on the touch pad 110.

In the case of (A1) where the five objects A, B, C, D, and E are presented on the object selection screen and, if the object C, for example, is to be selected, the touch operation on the touch pad 110 is carried out to scroll the object selection screen downward in such a manner that the mobile PC 16 first switches the object to be selected from the object C, B, to A, sequentially, and then switches the object again to delete the object E and cause the new object X to appear. Thus, the object X becomes a target for selection. In contrast, if the touch operation on the touch pad 110 is carried out to scroll the object selection screen upward, the mobile PC 16 first switches the object to be selected from the object C, D, to E, sequentially, and then switches the object again to delete the object A and cause the new object Y to appear. Thus, the object Y becomes a target for selection. When the selection of the object to be selected is commanded, the mobile PC 16 executes processing corresponding to the object.

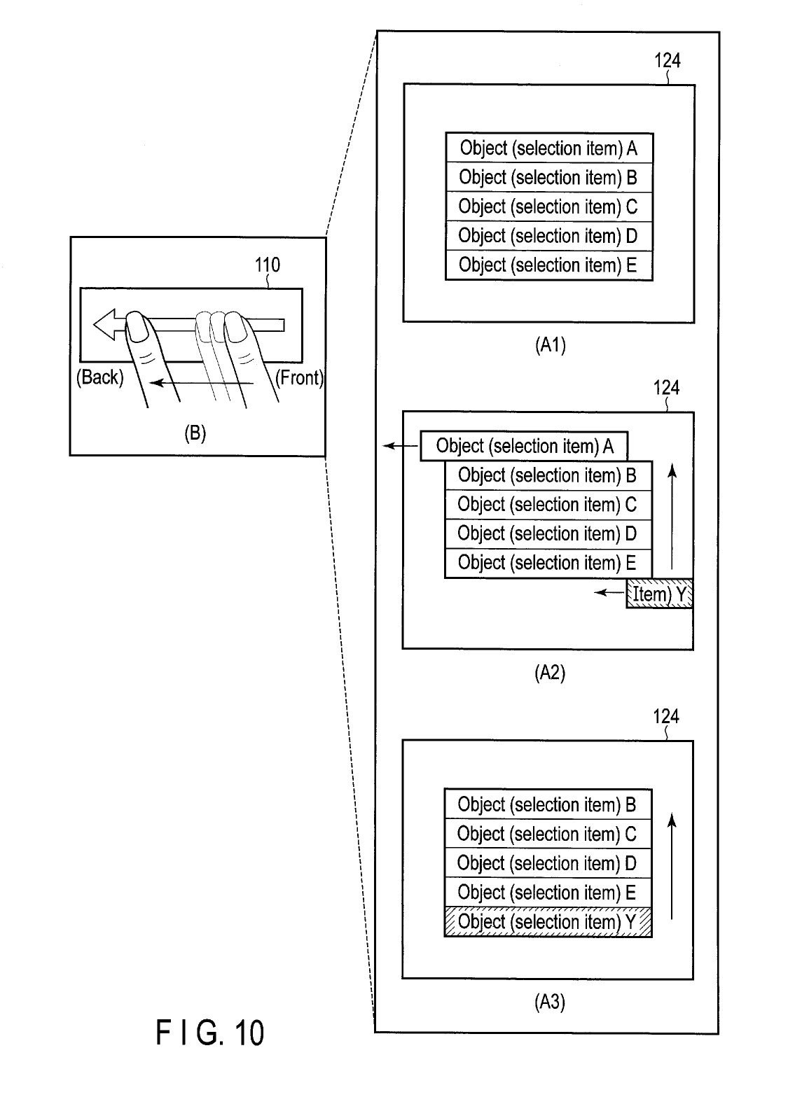

Next, by referring to FIG. 10, a second example of vertically moving the object displayed on the display 124 by the touch operation designating the horizontal direction on the touch pad 110 is described. Specifically, the touch operation on the touch pad 110 in the case of upward movement of the object displayed on the display 124 is described.

In FIG. 10, (A1) is similar to (A1) of FIG. 9, illustrating the display state of the object selection screen on the display 124 before the touch operation starts on the touch pad 110. Meanwhile, (B) illustrates the touch operation on the touch pad 110 to scroll up the object selection screen.

In order to scroll up the object selection screen or move the objects rearward, as illustrated in (B) of FIG. 10, the worker carries out the touch operation in, for example, the backward direction on the touch pad 110 along the temple of the spectacle frame 142. As used herein, the backward direction indicates a direction opposite to the line of sight of the worker. When the wearable device main body 24 is attached to the right temple of the spectacle frame 142, the backward direction corresponds to a right-hand direction on the touch pad 110. When the wearable device main body 24 is attached to the left temple of the spectacle frame 142, the backward direction corresponds to a left-hand direction on the touch pad 110.

(A2) illustrates a display state of the object selection screen on the display 124 when the touch operation designating the backward direction on the touch pad 110 is carried out halfway.

The mobile PC 16 gradually moves the objects on the display 124 upward in accordance with the touch operation designating the backward direction on the touch pad 110. At the same time, the mobile PC 16 gradually moves the object A, which is a target for scroll-out and located at the top of the objects A, B, C, D, and E, in the direction designated by the touch operation on the touch pad 110 to eventually delete the object A from the display 124. Also, the mobile PC 16 causes an object Y which is a target for scroll-in to appear on the display 124 from the side (right side) opposite to the direction designated by the touch operation on the touch pad 110 to gradually move the object Y in a direction (to the left) designated by the touch operation on the touch pad 110. The object Y appears and is put under the object E which is located at the bottom of the objects A, B, C, D, and E, and moves.

(A3) illustrates a display state of the object selection screen on the display 124 when the touch operation designating the backward direction on the touch pad 110 is finished.

The object A that has been located at the top of the objects A, B, C, D, and E before the touch operation has started on the touch pad 110 is deleted, and the other objects B, C, D, and E are each moved to one step higher of the list, with the new object Y being disposed at the bottom where the object E is used to be located. Thus, the upward scroll of the object selection screen has been completed.

As illustrated in (A2) of FIG. 10, the present embodiment carries out the actions matching the directions designated by the touch operation on the touch pad 110 as indicating the movement of the object A which is the target for scroll-out and the movement of the object Y which is the target for scroll-in. Thus, the object displayed on the display 124 can be moved vertically without generating the uncomfortable feeling with the touch operation designating the horizontal direction on the touch pad 110.

In this example, as described herein, the object displayed on the display 124 moves downward by the touch operation designating the forward direction on the touch pad 110 (see FIG. 9), and the object displayed on the display 124 moves upward by the touch operation designating the backward direction on the touch pad 110 (see FIG. 10). Alternatively, the relationship between the direction designated by the touch operation on the touch pad 110 and the direction in which the object displayed on the display 124 is moved may be reversed.

Specifically, when the touch operation designating the forward direction on the touch pad 110 is carried out, the mobile PC 16 gradually moves the object on the display 124 upward. At the same time, the object A, which is a target for scroll-out and located at the top of the objects A, B, C, D, and E, is moved in the direction designated by the touch operation on the touch pad 110 to eventually delete the object A from the display 124. Also, the mobile PC 16 causes an object Y which is a target for scroll-in to appear on the display 124 from the side opposite to the direction designated by the touch operation on the touch pad 110 to gradually move the object Y in a direction designated by the touch operation on the touch pad 110. Meanwhile, when the touch operation designating the backward direction on the touch pad 110 is carried out, the mobile PC 16 gradually moves the objects on the display 124 downward. At the same time, the object E, which is a target for scroll-out and located at the bottom of the objects A, B, C, D, and E, in the direction designated by the touch operation on the touch pad 110 to eventually delete the object E from the display 124. Also, the mobile PC 16 causes an object X which is a target for scroll-in to appear on the display 124 from the side opposite to the direction designated by the touch operation on the touch pad 110 to gradually move the object X in a direction designated by the touch operation on the touch pad 110.

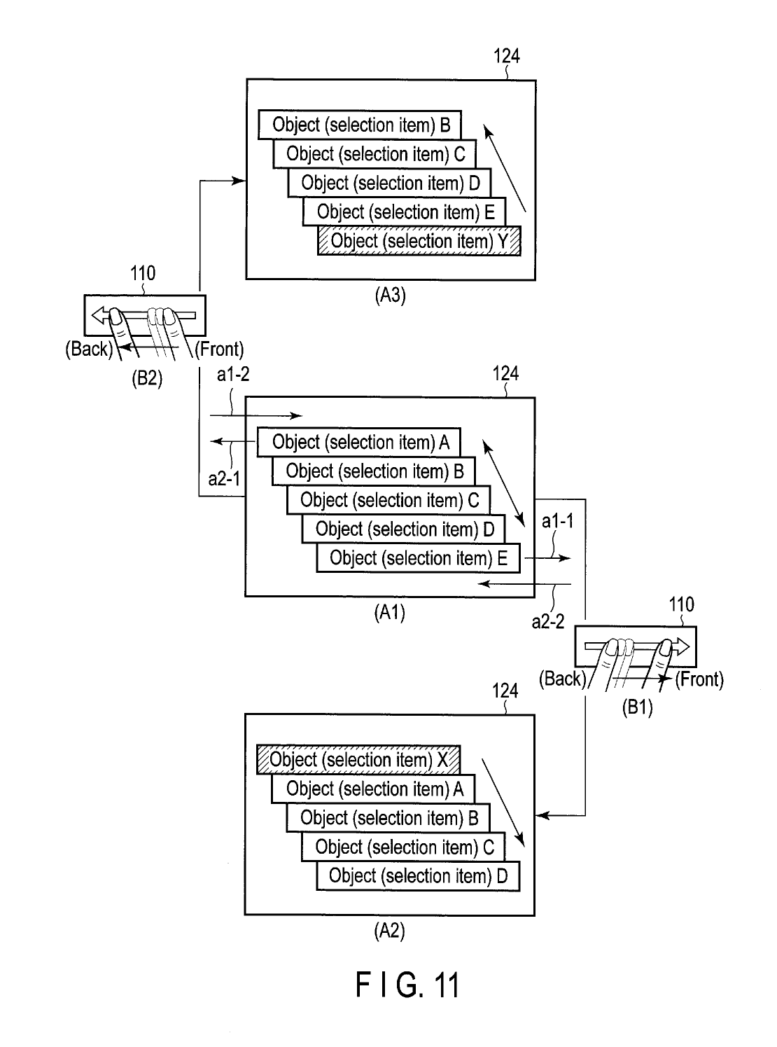

FIG. 11 is an arrangement example of the objects to further preventing the worker from having the uncomfortable feeling when the object displayed on the display 124 is moved vertically by the touch operation designating the horizontal direction on the touch pad 110.

In FIG. 11, (A1) illustrates a display state of the object selection screen on the display 124 before the touch operation is carried out on the touch pad 110. In this example, as illustrated in (A1), the objects presented on the object selection screen are shifted sequentially one by one in the horizontal direction by a predetermined width. For example, the object A located at the top of the objects A, B, C, D, and E is disposed at the leftmost position on the display 124, while the object E located at the bottom of the objects A, B, C, D, and E is disposed at the rightmost position on the display 124. In this arrangement, the worker can intuitively recognize that, in response to the touch operation designating the forward direction on the touch pad 110, the object E is deleted (a1-1), the new object is made to appear at the top (a1-2), and the downward scroll of the object selection screen is carried out. Meanwhile, the worker can also recognize that, in response to the touch operation designating the backward direction on the touch pad 110, the object A is deleted (a2-1), the new object is made to appear at the bottom (a2-2), and the upward scroll of the object selection screen is carried out.

(B1) illustrates the touch operation on the touch pad 110 carried out to scroll the object selection screen downward. (B2) illustrates the touch operation on the touch pad 110 carried out to scroll the object selection screen upward. (A2) illustrates a display state of the object selection screen on the display 124 when the touch operation designating the forward direction is finished on the touch pad 110. (A3) illustrates a display state of the object selection screen on the display 124 when the touch operation designating the backward direction is finished on the touch pad 110.

If it is desired to reverse the relationship between the direction designated by the touch operation on the touch pad 110 and the direction in which the object displayed on the display 124 is moved, each object presented on the object selection screen is shifted in the opposite direction. Specifically, for example, the object A that has been located at the top of the objects A, B, C, D, and E is disposed at the rightmost position on the display 124, while the object E that has been located at the bottom of the objects A, B, C, D, and E is disposed at the leftmost position on the display 124.

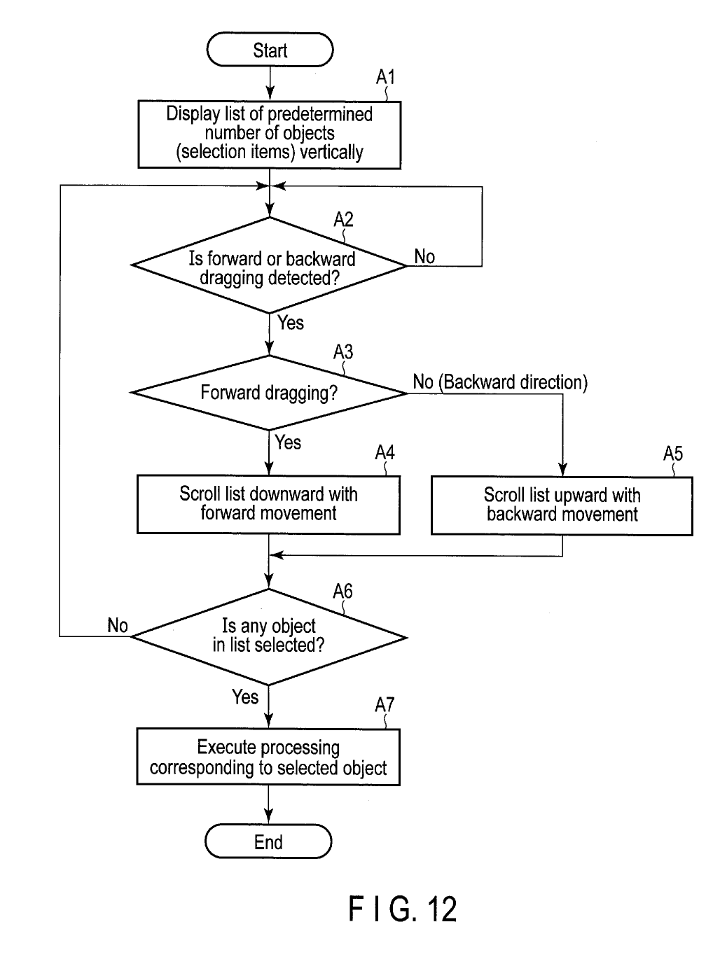

FIG. 12 is a flowchart showing an example of movement control of the object on the display 124 in accordance with the touch operation on the touch pad 110 by the mobile PC 16.

First, the mobile PC 16 displays a list of objects, such as a list of a predetermined number of objects arranged vertically, on the display 124 of the wearable device 23 (step A1). When the mobile PC 16 detects the touch operation (e.g., dragging) on the touch pad 110 designating the forward or backward direction, that is, the horizontal direction (step A2: YES), and the detected direction designates the forward direction (step A3: YES), the mobile PC 16 scrolls the list downward with the forward movement matching the forward designation (step A4). Meanwhile, if the backward direction is designated (step A3: NO), the mobile PC 16 scrolls the list upward with the backward movement matching the backward designation (step A5).

When any one of the objects of the list is selected (step A6: YES), that is, the target object for selection is designated, the mobile PC 16 executes processing corresponding to the selected object (step A7).

Thus, the present embodiment can vertically move the objects on the display 124 without generating the uncomfortable feeling by the touch operation designating the horizontal direction on the touch pad 110.

In the example described above, the mobile PC 16 controls the movement of the objects on the display 124 of the wearable device 23 by the touch operation of the wearable device 23 on the touch pad 110. Alternatively, the wearable device that can operate of its own can be controlled similarly.

Since the processing of the present embodiment can be implemented by a computer program, a similar effect can be easily obtained merely by installing and executing a computer program which is stored in a computer readable storage medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device connectable to a wearable device comprising a display and an operation device, the electronic device comprising:
an object display controller that controls display of an object on the display in response to an operation of the operation device,
wherein the object display controller
displays an object selection screen on the display, the object selection screen comprising a set of objects organized in a line in a first direction, the set of objects comprising selection items,
when the operation designates a second direction perpendicular to the first direction, moves a first object located at a first end of the line of the set of objects in the second direction to disappear the first object from the object selection screen, and
displays a second object different from any one of the set of objects at a second end of the line of the set of objects on the object selection screen to appear the second object from a third direction that is opposite to the second direction,
whereby the object selection screen is scrolled in the first direction.

2. The electronic device of claim 1, wherein
the operation device comprises a rectangular touch pad, and
the second direction comprises a longitudinal direction of the touch pad.

3. The electronic device of claim 2, wherein
the wearable device comprises an eyeglass frame, and
the touch pad is disposed at a temple of the eyeglass frame such that the longitudinal direction of the touch pad extends along the temple.

4. The electronic device of claim 3, wherein the object display controller,
when a first touch operation designating a first horizontal direction on the touch pad is carried out in such a way that the temple is traced along a direction of a line of sight, moves the first object located at a lower end of the line of the set of objects, which are organized vertically on the object selection screen, to disappear the first object from the object selection screen, and displays the second object at an upper end of the line of the set of objects on the object selection screen to appear the second object from a second horizontal direction that is opposite to the first horizontal direction, whereby the object selection screen is scrolled in a downward direction, and
when a second touch operation designating the second horizontal direction on the touch pad is carried out in such a way that the temple is traced along a direction opposite to the line of sight, moves a third object located at the upper end of the line of the set of objects in the second horizontal direction to disappear the third object from the object selection screen, and displays a fourth object different from any one of the set of objects at the lower end of the line of the set of objects on the object selection screen to appear the fourth object from the first horizontal direction, whereby the object selection screen is scrolled in an upward direction.

5. The electronic device of claim 3, wherein the object display controller,
when a first touch operation designating a first horizontal direction on the touch pad is carried out in such a way that the temple is traced along a direction of a line of sight, moves the first object located at an upper end of the line of the set of objects, which are organized vertically on the object selection screen, in the first horizontal direction to disappear the first object from the object selection screen, and displays the second object at a lower end of the line of the set of objects on the object selection screen to appear the second object from a second horizontal direction that is opposite to the first horizontal direction, whereby the object selection screen is scrolled in an upward direction, and
when a second touch operation designating the second horizontal direction on the touch pad is carried out in such a way that the temple is traced along a direction opposite to the line of sight, moves a third object located at the lower end of the line of the set of objects in the second horizontal direction to disappear the third object from the object selection screen, and displays a fourth object different from any one of the set of objects at the upper end of the line of the set of objects on the object selection screen to appear the fourth object from the first horizontal direction,
whereby the object selection screen is scrolled in a downward direction.

6. The electronic device of claim 1, wherein the object display controller arranges the line of the set of objects by shifting the set of objects sequentially one by one in the second direction by a predetermined width.

7. The electronic device of claim 6, wherein the object display controller,
when the operation designates the second direction, moves the first object located at the first end of the line of the set of objects and most shifted toward the second direction among the set of objects, in the second direction to disappear the first object from the object selection screen, and displays the second object on the object selection screen to appear the second object from the third direction, whereby the object selection screen is scrolled in the first direction, and
when the operation designates the third direction, moves a third object located at the second end of the line of the set of objects and most shifted toward the third direction among the set of objects, in the third direction to disappear the third object from the object selection screen, and displays a fourth object different from any one of the set of objects on the object selection screen from the second direction, whereby the object selection screen is scrolled in a fourth direction that is opposite to the first direction.

8. A wearable device comprising a display and an operation device, the wearable device comprising:
an object display controller that controls display of an object on the display in response to an operation of the operation device,
wherein the object display controller displays an object selection screen on the display, the object selection screen comprising a set of objects organized in a line in a first direction, the set of objects comprising selection items, and
when the operation designates a second direction perpendicular to the first direction, moves a first object located at a first end of the line of the set of objects in the second direction to disappear the first object from the object selection screen, and
displays a second object different from any one of the set of objects at a second end of the line of the set of objects on the object selection screen to appear the second object from a third direction that is opposite to the second direction, whereby the object selection screen is scrolled in the first direction.

9. The wearable device of claim 8, wherein
the operation device comprises a rectangular touch pad, and
the second direction comprises a longitudinal direction of the touch pad.

10. The wearable device of claim 9, wherein
the wearable device comprises an eyeglass frame, and
the touch pad is disposed at a temple of the eyeglass frame such that the longitudinal direction of the touch pad extends along the temple.

11. The wearable device of claim 10, wherein the object display controller,
when a first touch operation designating a first horizontal direction on the touch pad is carried out in such a way that the temple is traced along a direction of a line of sight, moves the first object located at a lower end of the line of the set of objects, which are organized vertically on the object selection screen, in the first horizontal direction to disappear the first object from the object selection screen, and displays the second object at an upper end of the line of the set of objects on the object selection screen to appear the second object from a second horizontal direction that is opposite to the first horizontal direction, whereby the object selection screen is scrolled in a downward direction, and
when a second touch operation designating the second horizontal direction on the touch pad is carried out in such a way that the temple is traced along a direction opposite to the line of sight, moves a third object located at the upper end of the line of the set of objects in the second horizontal direction to disappear the third object from the object selection screen, and displays a fourth object different from any one of the set of objects at the lower end of the line of the set of objects on the object selection screen to appear the fourth object from the first horizontal direction, whereby the object selection screen is scrolled in an upward direction.

12. The wearable device of claim 10, wherein the object display controller,
when a first touch operation designating a first horizontal direction on the touch pad is carried out in such a way that the temple is traced along a direction of a line of sight, moves the first object located at an upper end of the line of the set of objects, which are organized vertically on the object selection screen, in the first horizontal direction to disappear the first object from the object selection screen, and displays the second object at a lower end of the line of the set of objects on the object selection screen to appear the second object from a second horizontal direction that is opposite to the first horizontal direction, whereby the object selection screen is scrolled in an upward direction, and
when a second touch operation designating the second horizontal direction on the touch pad is carried out in such a way that the temple is traced along a direction opposite to the line of sight, moves a third object located at the lower end of the line of the set of objects in the second horizontal direction to disappear the third object from the object selection screen, and displays a fourth object different from any one of the set of objects at the upper end of the line of the set of objects on the object selection screen to appear the fourth object from the first horizontal direction, whereby the object selection screen is scrolled in a downward direction.

13. The wearable device of claim 8, wherein the object display controller arranges the line of the set of objects by shifting the set of objects sequentially one by one in the second direction by a predetermined width.

14. The wearable device of claim 13, wherein the object display controller,
when the operation designates the second direction, moves the first object located at a first end of the line of the set of objects and most shifted toward the second direction among the set of objects, in the second direction to disappear the object from the object selection screen, and displays the second object at a second end of the line of the set of objects on the object selection screen to appear the second object from the third direction, whereby the object selection screen is scrolled in the first direction, and
when the operation designates the third direction, moves a third object located at the second end of the line of the set of objects and most shifted toward the third direction among the set of objects, in the third direction to disappear the third object from the object selection screen, and displays a fourth object different from any one of the set of objects on the object selection screen to appear the fourth object from the second direction, whereby the object selection screen is scrolled in a fourth direction that is opposite to the first direction.

15. A display control method of a wearable device comprising a display and an operation device, the display control method comprising:
displaying an object selection screen on the display, the object selection screen comprising a set of objects organized in a line in a first direction, the set of objects comprising selection items;
when the operation designates a second direction perpendicular to the first direction,
moving a first object located at a first end of the line of the set of objects in the second direction to disappear the first object from the object selection screen; and
displaying a second object different from any one of the set of objects at a second end of the line of the set of objects on the object selection screen to appear the second object from a third direction that is opposite to the second direction,
whereby the object selection screen is scrolled in the first direction.

16. The display control method of claim 15, wherein
the wearable device comprises an eyeglass frame,
the operation device comprises a touch pad disposed such that the longitudinal direction of the touch pad extends along a temple of the spectacle frame, and
the display control method further comprises
when a first touch operation designating a first horizontal direction on the touch pad is carried out in such a way that the temple is traced along a direction of a line of sight,
moving the first object located at a lower end of the line of the set of objects, which are organized vertically on the object selection screen, in the first horizontal direction to disappear the first object from the object selection screen, and
displaying the second object at an upper end of the line of the set of objects on the object selection screen to appear the second object from a second horizontal direction that is opposite to the first horizontal direction,
whereby the object selection screen is scrolled in a downward direction; and
when a second touch operation designating the second horizontal direction on the touch pad is carried out in such a way that the temple is traced along a direction opposite to the line of sight,
moving a third object located at the upper end of the line of the set of objects in the second horizontal direction to disappear the third object from the object selection screen, and
displaying a fourth object different from any one of the set of objects at the lower end of the line of the set of objects on the object selection screen to appear the fourth object from the first horizontal direction,
whereby the object selection screen is scrolled in an upward direction.

17. The display control method of claim 15, wherein
the wearable device comprises an eyeglass frame,
the operation device comprises a touch pad disposed such that the longitudinal direction of the touch pad extends along the temple of the spectacle frame, and
the display control method further comprises
when a first touch operation designating a first horizontal direction on the touch pad is carried out in such a way that the temple is traced along a direction of a line of sight,
moving the first object located at an upper end of the line of the set of objects, which are organized vertically on the object selection screen, in the first horizontal direction to disappear the first object from the object selection screen, and
displaying the second object at a lower end of the line of the set of objects on the object selection screen to appear the second object from a second horizontal direction that is opposite to the first horizontal direction,
whereby the object selection screen is scrolled in an upward direction; and
when a second touch operation designating the second horizontal direction on the touch pad is carried out in such a way that the temple is traced along a direction opposite to the line of sight,
moving a third object located at the lower end of the line of the set of objects in the second horizontal direction to disappear the third object from the object selection screen, and
displaying a fourth object different from any one of the set of objects at the upper end of the line of the set of objects on the object selection screen to appear the fourth object from the first horizontal direction,
whereby the object selection screen is scrolled in a downward direction.

18. The display control method of claim 15, further comprising:
arranging the line of the set of objects by shifting the set of objects sequentially one by one in the second direction by a predetermined width.

19. The display control method of claim 16, further comprising:
when the operation designates the second direction,
moving the first object located at the first end of the line of the set of objects and most shifted toward the second direction among the set of objects, in the second direction to disappear the first object from the object selection screen, and
displaying the second object at the second end of the line of the set of objects on the object selection screen to appear the second object from the third direction opposite to the second direction,
whereby the object selection screen is scrolled in the first direction; and
when the operation designates the third direction,
moving a third object located at the second end of the line of the set of objects and most shifted toward the third direction among the set of objects, in the third direction to disappear the third object from the object selection screen, and
displaying a fourth object different from any one of the set of objects at the first end of the line of the set of objects on the object selection screen to appear the fourth object from the second direction,
whereby the object selection screen is scrolled in a fourth direction that is opposite to the first direction.
